(19) United States
(12) Patent Application Publication
(10) Pub. No.: US 2010/0021811 A1
(43) Pub. Date: Jan. 28, 2010

(54) SEALED BATTERY

(76) Inventors: Hiroyasu KADO, Toyota-shi (JP); Mutsumi SHIDU, Toyota-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/506,303

(22) Filed: Jul. 21, 2009

(30) Foreign Application Priority Data
Jul. 23, 2008 (JP) 2008-190323

(51) Int. Cl. H01M 2/08

(52) U.S. Cl. 429/185

(57) ABSTRACT

A sealed battery includes a battery container, a lid body attached to an opening portion of the battery container, and a terminal extraction portion provided on a lid main body of the lid body. The battery container is sealed by joining an opening peripheral edge portion thereof to a peripheral edge portion of the lid body and crimping an electrode terminal inserted into the terminal extraction portion using the terminal extraction portion. At least a part of the terminal extraction portion in which the crimp is formed is constituted by a metallic material having a higher strength than a part of the lid body that is joined to the battery container.

### INCORPORATION BY REFERENCE

The disclosure of Japanese Patent Application No. 2008-190323 filed on Jul. 23, 2008, including the specification, drawings and abstract is incorporated herein by reference in its entirety.

### BACKGROUND OF THE INVENTION

1. Field of the Invention

The invention relates to a sealed battery, and more particularly to a sealed battery in which a joint portion of a lid body that is joined to a battery container and a terminal extraction portion are formed from metallic materials having different strengths.

2. Description of the Related Art

In recent years, lithium ion batteries, nickel hydrogen batteries, and other secondary batteries have grown in importance as power supplies installed in vehicles and power supplies for personal computers and portable terminals. Particularly high expectations have been placed on lithium ion batteries, which are lightweight and from which a high energy density is obtained, in relation to favorable use thereof as a high output power supply installed in a vehicle. A conventional embodiment of a lithium ion battery or another battery is a so-called sealed battery in which an electrode body is housed in a battery container of a predetermined shape (for example, an angular or cylindrical shape) together with an electrolyte and an opening portion of the battery container is sealed.

In this type of battery, a high degree of reliability in the sealing structure is required in two locations, namely a joint portion provided between the battery container and a lid body attached to the opening portion of the container (in other words, an opening peripheral edge portion of the battery container and a peripheral edge portion of the lid body) and a part (a terminal extraction portion) into which an electrode terminal (typically a rod-shaped electrode terminal) provided in the lid body is inserted such that the electrode terminal is fixed to the lid body while penetrating the part so as to project from the lid body. For example, the sealing structure of a battery installed in a vehicle requires a much higher degree of reliability than a battery for general applications. The reliability includes a moisture penetration property into the sealing structure (durability), a vibration resistance property, and so on. Further, in addition to a superior sealing property between the lid body and the electrode terminal, the terminal extraction portion must also exhibit a superior insulating property. As a sealing structure for the terminal extraction portion described above, which requires both a superior sealing property and a superior insulating property, Japanese Patent Application Publication No. 2005-183359 (JP-A-2005-183359), Japanese Patent Application Publication No. 2001-176495 (JP-A-2001-176495), Japanese Patent Application Publication No. 8-250083 (JP-A-8-250083), and Japanese Patent Application Publication No. 7-235289 (JP-A-7-235289), for example, describe structures in which an insulating member (an insulating gasket) is sandwiched between an inner wall surface of the terminal extraction portion and a terminal and the terminal is fixed via the insulating member by various types of crimping. Japanese Patent No. 3334804 B describes another mode of a crimp structure. More specifically, Japanese Patent No. 3334804 B describes a sealing structure (crimp structure) for a through hole of a metallic partitioning member in which a penetrating member (core member) covered by a synthetic resin sealing member is inserted into a through hole in the metallic partitioning member, whereupon pressure is applied to a peripheral part of the through hole in an axial direction of the penetrating member to subject the peripheral part to plastic deformation in an inner diameter direction of the through hole (in other words, a part of the metallic partitioning member is plastically deformed to form a bulging portion jutting toward an inner wall surface of the hole), thereby fixing the penetrating member (core member) and sealing the through hole (see FIGS. 1 to 3 of Japanese Patent No. 3334804, for example).

In the sealing structures described above, the lid body is typically molded by fashioning a member (plate body) formed from a single material and having a single characteristic. Therefore, the peripheral edge portion of the lid body joined to the battery container and the terminal extraction portion for fixing the electrode terminal, which is inserted therein in a projecting fashion, to the lid body, are constituted by a material having a constant strength. In consideration of the joining ability between the opening peripheral edge portion of the battery container and the lid body (i.e. the ease of joining or favorable workability), a flexible metallic material having a high degree of purity (for example, an aluminum-based metallic material, typically a 1000 Series aluminum alloy material (note that names such as “1000 Series” are based on JIS and international aluminum alloy names)) may be used favorably as the material of the lid body. In the terminal extraction portion, on the other hand, a resin material (engineering plastic, for example) that can be used favorably to secure the sealing property may have a strength that is approximately equal to or greater than the metallic material described above. Hence, when external pressure is applied to a flexible metallic material such as that described above in the terminal extraction portion to crimp the electrode terminal via the resin insulating member, the metallic material may gradually loosen due to a repulsive force of the resin, and as a result, it may be impossible to maintain the sealing property over the long term. On the other hand, when the lid body is molded from a high-strength metallic material (for example, a 5000 Series aluminum alloy material) in consideration of the sealing property of the terminal extraction portion, the sealing property of the terminal extraction portion is secured, but since the material lacks workability, it is difficult to join the opening peripheral edge portion of the battery container to the lid body (through crimping, seaming, or welding, for example). Furthermore, in a case where the battery container and the lid body are formed from metallic materials having different compositions, the surface area (joint area) of the opening peripheral edge portion of the battery container and the peripheral edge portion of the lid body is large, and therefore, even when a local joining technique such as that disclosed in Japanese Patent Application Publication No. 2006-263809 (JP-A-2006-263809), for example, is employed, it is difficult to achieve a strong joint over the entire joint portion.

### SUMMARY OF THE INVENTION

The invention provides a sealed battery with which a peripheral edge portion of an opening portion of a battery container and a peripheral edge portion of a lid body can be joined easily, and a terminal extraction portion for fixing an electrode terminal that penetrates the terminal extraction portion so as to project from the lid body to the lid body can be sealed such that a superior sealing property is maintained in the battery container long-term.

An aspect of the invention relates to a sealed battery including a battery container, a lid body attached to an opening portion of the battery container, and a terminal extraction portion provided on the lid body, in which an electrode terminal is inserted fixedly. The battery container of this battery is sealed by joining a peripheral edge portion of the opening portion and a peripheral edge portion of the lid body and crimping the electrode terminal inserted into the terminal extraction portion of the lid body using the terminal extraction portion. At least a part of the terminal extraction portion in which the crimp is formed is constituted by a metallic material having a higher strength than a part of the lid body that is joined to the battery container (typically a metallic material having a different composition to and a higher strength than the part of the lid body that is joined to the battery container).

In the sealed battery having this constitution, the lid body is constituted by the terminal extraction portion and a lid main body (the part of the lid body other than the terminal extraction portion). Here, at least the part of the terminal extraction portion in which the crimp is formed is constituted by a metallic material (typically a metallic material having a different composition to and a higher strength than the part of the lid body that is joined to the battery container, i.e. a peripheral edge portion of the lid main body of the lid body (lid main body) that is joined to a peripheral edge of an opening portion (an opening peripheral edge portion) of the battery container). Further, a joining area of at least the part of the terminal extraction portion in which the crimp is formed is smaller than the peripheral edge portion of the lid body (lid main body) and local. Hence, the joint between at least the part of the terminal extraction portion in which the crimp is formed and the other part (the joint between the terminal extraction portion and the lid main body) can be formed easily and securely even when the respective parts are constituted by materials having different properties (strengths and/or compositions).

Further, at least the part of the terminal extraction portion in which the crimp is formed (the crimp forming part) is constituted by a metallic material having a higher strength (including a higher hardness value or higher yield stress) than the peripheral edge portion (the part of the lid body that is joined to the battery container) of the lid main body. Therefore, a gap between the electrode terminal and the terminal extraction portion can be sealed securely by crimping. On the other hand, the peripheral edge portion of the lid main body may be constituted by a metallic material having a lower strength (including greater flexibility or lower yield stress) than the crimp forming part, and therefore the joint with the opening peripheral edge portion of the battery container can be formed easily. Hence, according to this constitution, a favorable sealed battery with which the opening peripheral edge portion of the battery container and the peripheral edge portion of the lid body (lid main body) can be joined easily and the terminal extraction portion can be sealed reliably such that the sealing property of the battery container is maintained long-term can be provided.

At least the crimp forming part of the terminal extraction portion and a part of the lid body other than the crimp forming part may be constituted by aluminum alloy materials having different hardness values. An aluminum alloy material is reasonably priced, easily available, and has a wide range of use. Further, characteristics of an aluminum alloy material such as material strength and workability vary according to the composition of added elements (alloying elements such as Mg, Cu, Si, and Mn, for example), and therefore aluminum alloy materials are classified as 1000 Series to 7000 Series aluminum alloys. According to this constitution, easily available aluminum alloy materials having different hardness values are used in the respective sites of the lid main body of the battery to manufacture the lid main body of the battery, and therefore a joint can be formed easily between the opening peripheral edge portion of the battery container and the peripheral portion of the lid body (lid main body), and the terminal extraction portion can be sealed reliably such that the sealing property of the battery container is maintained long term. Here, aluminum alloy materials having an identical composition, in which the hardness values are differentiated by varying heat treatment conditions, degrees of processing, and so on or aluminum alloy materials having different hardness values due to compositional differences may be used as the aluminum alloy materials having different hardness values.

At least the crimp forming part of the terminal extraction portion and the part of the lid body other than the crimp forming part may be constituted by aluminum alloy materials having different added element compositions. According to the sealed battery having this constitution, as the aluminum materials having different hardness values described above, a high-hardness aluminum alloy (for example, a 2000 Series, 5000 Series or 6000 Series aluminum alloy) is used in at least the part of the terminal extraction portion in which the crimp is formed, and a flexible (low strength, low hardness), workable (easily joinable) aluminum alloy (for example, a 1000 Series aluminum alloy or pure aluminum) is used in the lid body part other than the crimp forming part, and therefore the opening peripheral edge portion of the battery container and the peripheral edge portion of the lid body can be joined easily and the terminal extraction portion can be sealed reliably such that a superior sealing property is maintained in the battery container over the long term.

The battery container may be constituted by an identical metallic material to the part of the lid body other than the terminal extraction portion. According to this constitution, the battery container and the lid main body are constituted by an identical metallic material, and therefore the opening peripheral edge portion of the container and the peripheral edge portion of the lid body can be joined even more easily using a joining method such as laser welding, crimping, or seaming, for example.

An insulating member may be disposed between the terminal extraction portion and the electrode terminal, and the electrode terminal may be crimped via the insulating member. According to this constitution, the insulating member is disposed (typically inserted) between the terminal extraction portion and the electrode terminal, and the electrode terminal is crimped via the insulating member using the terminal extraction portion. Thus, the terminal extraction portion and the electrode terminal are sealed more reliably, enabling a further improvement in the sealing property of the battery container. A member constituted by a resin material having a strength that is approximately equal to or slightly lower than the metallic (aluminum alloy) material of the terminal extraction portion may be used favorably as the insulating member.

At least the crimp forming part of the terminal extraction portion and the part of the lid body other than the crimp forming part may be joined by solid phase welding. According to this constitution, at least the part of the terminal extraction portion in which the crimp is formed and the lid body part other than the crimp forming part may be joined locally by bringing the respective joinable parts thereof into contact, and therefore the two parts can be joined easily through a solid phase welding method (for example, friction stirring welding, ultrasonic bonding, and so on).

A second aspect of the present invention relates to a sealed battery including a battery container, a lid body attached to an opening portion of the battery container, and a terminal extraction portion provided on the lid body, in which an electrode terminal is inserted fixedly. The battery container is sealed by joining a peripheral edge portion of the opening portion and a peripheral edge portion of the lid body and crimping the terminal extraction portion so that the electrode terminal inserted into the terminal extraction portion is fixed to the terminal extraction portion. At least a crimp forming part of the terminal extraction portion in which the crimp is formed is constituted by a metallic material having a higher strength than a part of the lid body that is joined to the battery container.

Further, as a result of the joint between the opening peripheral edge portion of the battery container and the peripheral edge portion of the lid body and the crimp on the terminal extraction portion of the lid body, the sealed battery is provided with a highly reliable sealing structure. Therefore, the sealed battery can be used favorably as a battery installed in a vehicle. Hence, according to the invention, a vehicle (an automobile, for example) including the sealed battery is provided.

### BRIEF DESCRIPTION OF THE DRAWINGS

The foregoing and further objects, features and advantages of the invention will become apparent from the following description of exemplary embodiments with reference to the accompanying drawings, wherein like numerals are used to represent like elements, and wherein:

FIG. 1 is a schematic sectional view showing the constitution of a sealed battery according to an embodiment;

FIG. 2 is a schematic sectional view showing an enlargement of a part surrounded by a dot-dot-dash line II in FIG. 1;

FIG. 3 is a schematic sectional view illustrating another embodiment of the manner in which a positive electrode terminal is fixed to a terminal extraction portion;

FIG. 4 is a schematic sectional view illustrating a further embodiment of the manner in which the positive electrode terminal is fixed to the terminal extraction portion;

FIG. 5 is a schematic sectional view illustrating a further embodiment of the manner in which the positive electrode terminal is fixed to the terminal extraction portion; and

FIG. 6 is a schematic side view showing a vehicle (an automobile) installed with the sealed battery according to this embodiment.

### DETAILED DESCRIPTION OF EMBODIMENTS

A preferred embodiment of the invention will be described below with reference to the drawings. Matter required to implement the invention other than the items mentioned specifically in this specification (for example, the constitution and construction procedure of the sealed battery, general technology relating to battery construction, and so on) may be understood by a person skilled in the art as design items based on the related art of the corresponding field. The invention may be implemented on the basis of the content disclosed in the specification and technical common knowledge relating to the field. In this specification, the term “battery” encompasses all types of chemical batteries, such as a lithium secondary battery, a lithium ion battery, a nickel hydrogen battery, a nickel cadmium battery, and a lead storage battery, as well as storage devices (physical cells) such as electric double layer capacitors that can be used in a similar manner and in similar industrial fields to these various types of chemical batteries. Further, in the drawings to be described below, identical reference symbols have been allocated to members/sites exhibiting identical actions. The structure of a sealed battery according to the invention will be described in detail below using an angular sealed lithium ion battery as an example. However, the invention is not limited to the sealed battery described in the embodiment. Further, dimensional relationships (length, width, thickness, and so on) in the drawings do not reflect actual dimensional relationships.

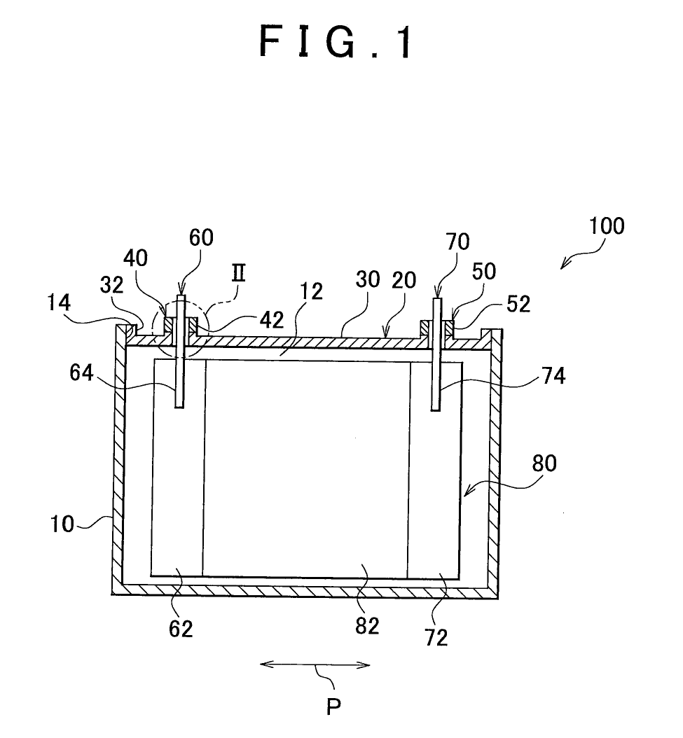

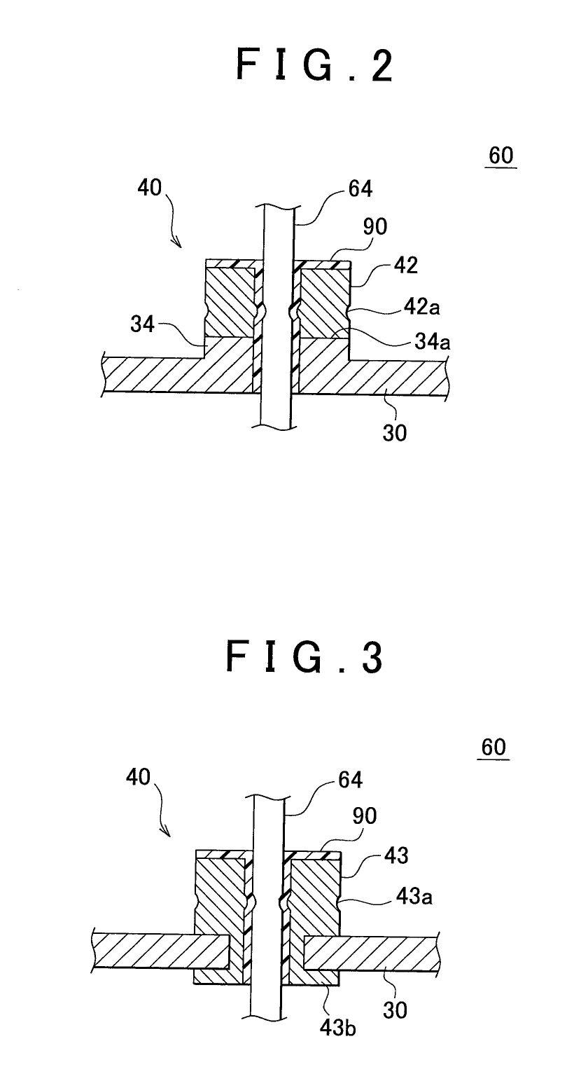

Referring to FIGS. 1 and 2, a sealed battery 100 (also referred to simply as a “battery” hereafter) according to this embodiment will be described. FIG. 1 is a schematic sectional view showing the structure of the battery 100 according to an embodiment of the invention, and FIG. 2 is a schematic sectional view showing an enlargement of a part (a terminal extraction portion) surrounded by a dotted line II in FIG. 1. Note that in FIGS. 1 and 2, electrode terminals 64, 74 are not shown in cross-section. The battery 100 according to this embodiment basically includes, similarly to a conventional battery, an electrode body 80 including predetermined battery constitutional materials (respective active materials of a positive electrode 60 and a negative electrode 70, respective collectors (collection portions 62, 72) of the positive electrode 60 and the negative electrode 70, a separator 82, and so on), a battery container 10 housing the electrode body 80 and an appropriate electrolyte (typically a liquid electrolyte), and a lid body 20 closing an opening portion 12 of the battery container 10. Further, a positive electrode terminal 64 and a negative electrode terminal 74 are inserted into the lid body 20 in the vicinity of the two end portions of the lid body 20 in a width (lengthwise) direction P and fixed within terminal extraction portions 40, 50 of the lid body 20 so as to project from the lid body 20. Note that in the following description, the featured parts of this embodiment will be described mainly in relation to the positive electrode 60 side. However, application of the terminal extraction portion according to the invention is not limited to the positive electrode 60 side, and the invention may be applied to both the positive electrode 60 side and the negative electrode 70 side or either one of the positive electrode 60 side and the negative electrode 70 side. In the battery 100 according to this embodiment, the terminal extraction portions 40, 50 on the positive electrode 60 side and the negative electrode 70 side are structured substantially identically.

There are no particular limitations on the shape of the battery container 10, and any shape that is capable of housing the electrode body 80, such as a cylindrical shape or an angular shape, may be employed. Further, the battery container 10 should be constituted such that at least one end portion thereof is open so that the electrode body 80 can be accommodated through the opening portion 12. As shown in FIG. 1, the battery container 10 according to this embodiment takes a closed-end angular shape in which the opening portion 12 is provided in one end portion. A peripheral edge portion 14 of the opening portion 12 is rectangular. The battery container 10 is preferably constituted by a metallic material that is lightweight, exhibits superior thermal conductivity, and is highly workable. Preferred examples of such a metallic material include an aluminum alloy (including an industrial pure aluminum-based material), stainless steel, nickel plated steel, and so on. However, taking into consideration a joining ability between the battery container 10 and the lid body 20 (i.e. ease of joining or favorable workability), to be described below, an aluminum alloy material that is flexible (exhibits low strength, low hardness, or low yield stress) and has a high degree of purity is more preferable. Typically, a 1000 Series aluminum alloy material (an industrial pure aluminum-based material), and in particular A1050 or A1070, may be used favorably as the constitutional material of the battery container 10.

The lid body 20 is constituted by a lid main body 30 that covers the opening portion 12 of the battery container 10 and takes a flat plate shape corresponding to a shape capable of closing the opening portion 12, and the terminal extraction portions 40, 50, which are provided in predetermined locations of the lid main body 30 (in the vicinity of the two end portions in the width direction P) and in which the rod-shaped electrode terminals 64, 74 are respectively inserted and fixed, for example. The lid main body 30 has a similar shape (rectangular in this embodiment) to the opening peripheral edge portion 14, and a peripheral edge portion 32 of the lid main body 30 is joined to the opening peripheral edge portion 14 of the battery container 10 using one of various joining methods (for example, laser welding, rolling crimping, seaming, and so on). The material of the lid main body 30 may be different to the material of the battery container 10 but is preferably identical to the material of the battery container 10 to ensure that the peripheral edge portion 32 of the lid main body 30 and the opening peripheral edge portion 14 of the battery container 10 can be joined easily. A flexible (low strength, low hardness, or low yield stress) aluminum alloy material is particularly preferable. Typically, a 1000 Series aluminum alloy material (an industrial pure aluminum-based material), and in particular A1050 or A1070, may be used favorably as the constitutional material of the lid main body 30.

The terminal extraction portion 40 is constituted by a cylindrical projecting portion 34 which is typically formed integrally with the lid main body 30 so as to rise slightly upward from a planar part of the lid main body 30, and a cylindrical crimp formation portion 42 (a part of the terminal extraction portion 40 that is crimped) joined to an upper end surface 34a of the projecting portion 34. Thus, the terminal extraction portion 40 takes an overall cylindrical shape. A columnar space in an axial center part of the cylindrical terminal extraction portion 40, or in other words a space surrounded by an inner peripheral surface of the terminal extraction portion 40, serves as a space into which the positive electrode terminal 64 is inserted in an orthogonal orientation to a planar direction of the lid main body 30. In another preferred embodiment of the terminal extraction portion 40, the projecting portion 34 may be omitted such that a lower end surface of the cylindrical crimp formation portion 42 is joined directly to the planar part of the lid main body 30. Further, the projecting portion 34 may be prepared as a separate body that is joined to the lid main body 30, rather than being formed integrally with the lid main body 30.

In the terminal extraction portion 40 into which the round rod-shaped positive electrode terminal 64 is inserted, for example, an insulating member 90 is disposed (inserted) without gaps into a tubular (cylindrical) space formed by the inner peripheral surface of the terminal extraction portion 40 and an outer peripheral surface of the positive electrode terminal 64 such that the terminal extraction portion 40 and the positive electrode terminal 64 are insulated from each other. The insulating member 90 may also be disposed to cover an upper end surface of the crimp formation portion 42 in addition to the outer peripheral surface of the part of the positive electrode terminal 64 that is inserted into the terminal extraction portion 40, or in other words have a substantially T-shaped cross-sectional constitution including a cylindrical part that contacts the outer peripheral surface of the positive electrode terminal 64 and a flange part that contacts the upper end surface of the crimp formation portion 42 on one axial end side thereof. A crimp (42a in FIG. 2) is formed on the crimp formation portion 42. Here, the term “crimp” denotes processing performed on a part of the outer peripheral surface of the crimp formation portion 42 to form an indentation oriented in the axial center direction of the cylindrical crimp formation portion 42 or the part (42a) itself that is formed by this processing. In a preferred embodiment of the crimp formed on the crimp formation portion 42, a crimp (i.e. a rolling crimp) is formed at a predetermined width in a circumferential direction in a predetermined position (for example, in the vicinity of a central portion of the overall height of the terminal extraction portion 40) on the outer peripheral surface of the crimp formation portion 42. Alternatively, crimps formed in spot fashion (for example, pinpoint pressed parts) may be provided in two opposing locations or a plurality of locations in a radial direction of the crimp formation portion 42.

The material of the crimp formation portion 42 of the terminal extraction portion 40 is preferably a high strength (or high hardness or high yield stress) material. In particular, a metallic material having a high strength that is equal to or greater than the high-strength insulating member 90 is preferably employed as the constitutional material of the crimp formation portion 42 so that the outer peripheral surface of the positive electrode terminal 64 and the inner peripheral surface of the insulating member 90 are sealed reliably by the crimp. When the crimp formation portion 42 is formed from this type of metallic material, the crimped part resists a repulsive force of the insulating member 90, and therefore the crimp is prevented from loosing over the long term. Examples of this metallic material include a high-strength aluminum alloy material, for example a 2000 Series, 5000 Series or 6000 Series aluminum alloy material, and more specifically, A2017 (duralumin), A2024 (super duralumin), A5052, A5056, A6061, A6063, and so on may be used favorably. Characteristics of the aluminum alloy material such as material strength, workability, and so on differ according to the composition of the added elements (i.e. the alloying elements, for example Mg, Cu, Si, Mn, and so on). For example, a 1000 Series aluminum alloy material suitable for use in the battery container 10 and so on is a pure aluminum-based material having a purity of at least 99.0% (in particular, A1050 has a purity of at least 99.50% and A1070 has a purity of at least 99.70%). As regards the strength of A1050, for example, the tensile strength is 127 [MPa], the load bearing capacity is 78 [MPa], and the hardness is 20 [HB]. In contrast, a 2000 Series aluminum alloy is an alloy having Cu as its main added element. For example, A2017 has a tensile strength of 373 [MPa], a load bearing capacity of 118 [MPa], and a hardness of 105 [HB]. In a 5000 Series-based alloy, the main added element is Mg, and in A5052, for example, the tensile strength is 226 [MPa], the load bearing capacity is 118 [MPa], and the hardness is 60 [HB]. Further, in a 6000 Series-based alloy, the main added element is Mg or Si, and in A6063, for example, the tensile strength is 186 [MPa], the load bearing capacity is 98 [MPa], and the hardness is 60 [HB]. Hence, the added element composition differs between an aluminum alloy material having a suitable strength for the battery container 10, the lid main body 30, and so on and an aluminum alloy material having a suitable strength for the crimp formation portion 42, and by using these materials appropriately, the respective required strengths can be obtained. Note that in this embodiment, the respective strengths (hardness values) of an aluminum alloy material having a suitable strength for the battery container 10, the lid main body 30, and so on and an aluminum alloy material having a suitable strength for the crimp formation portion 42 are differentiated by employing materials having different compositions. However, in addition to this embodiment, an embodiment in which the respective hardness values are differentiated by varying (adjusting) heat treatment conditions and degrees of processing in relation to aluminum alloy materials having identical compositions may be employed.

A high-strength insulating material is preferably employed as the constitutional material of the insulating member 90 to ensure that the outer peripheral surface of the positive electrode terminal 64 and the inner peripheral surface of the insulating member 90 are sealed reliably by the crimp, as described above. By employing a high-strength insulating material, compressive creep can be prevented over the long term even when a part of the insulating member 90 is pressed (compressed) by the crimp, and therefore the sealing structure of the terminal extraction portion 40 can be formed reliably. A highly insulating resin material is preferably employed as the constitutional material of the insulating member 90. For example, an engineering plastic, or more preferably a super engineering plastic having an even higher heat-resistant temperature, such as tetrafluoroethylene-perfluoroalkylvinyl ether copolymer (PFA), polyphenylene sulfide (PPS), or polyether ether ketone (PEEK), is used. The terminal extraction portion 40 on the positive electrode 60 side and the insulating member 90 used therein were described above, but the terminal extraction portion 50 on the negative electrode 70 side is substantially identical to the positive electrode 60 side, and therefore also has a favorable sealing structure.

The positive electrode terminal 64 according to this embodiment takes a rod shape having a circular cross-section, for example. Further, one end of the terminal 64 is connected to the collector (collection portion 62) of the positive electrode 60 of the electrode body 80 and the other end is inserted into the terminal extraction portion 40 of the lid body 20 so as to project from the lid body 20. In this state, the positive electrode terminal 64 is pressed by the crimp via the insulating member 90 contacting the outer peripheral surface of the terminal 64, and thereby fixed within the terminal extraction portion 40. The negative electrode terminal 74 is subjected to an identical process. A similar metallic material (for example, an aluminum alloy (including industrial pure aluminum)) to that of the positive electrode collector connected to the terminal 64 may be used favorably as the constitutional material of the positive electrode terminal 64. On the other hand, a similar metallic material (copper, for example) to that of the collector (collection portion 72) of the negative electrode 70 connected to the negative electrode terminal 74 may be used favorably as the constitutional material of the negative electrode terminal 74.

As regards the electrode body 80 having a predetermined battery constitutional material, as long as the positive electrode terminal 64 and the negative electrode terminal 74 connected to the respective collectors of the positive electrode 60 and negative electrode 70 at one end are formed such that the other end thereof can project from the vicinity of the two end portions of the battery container 10 in the width direction P when the electrode body 80 is housed in the battery container 10, there are no particular limitations on the shape thereof, and the electrode body 80 may be laminated, rolled, and so on. In a preferred embodiment, the electrode body is a rolled electrode body in which a positive electrode sheet formed by applying a positive electrode active material layer to a positive electrode collecting foil body and a negative electrode sheet formed by applying a negative electrode active material layer to a negative electrode collecting foil body are laminated via a separator 82 such that exposed parts of the collecting foil bodies of the respective electrode sheets are disposed at the two end portions in a rolling direction. The electrode body 80 according to this embodiment has a flat shape obtained by pressing the above rolled body from a side face direction so that the electrode body 80 can be housed in the angular battery container 10. The positive electrode terminal 64 and the negative electrode terminal 74 are respective connected to the positive electrode collecting portion 62 and the negative electrode collecting portion 72 (the parts in which the respective exposed parts of the positive electrode collecting foil body and the negative electrode collecting foil body are rolled and laminated) on the respective axial end portions thereof.

There are no particular limitations on the constitutional material of the electrode body 80 of the sealed battery 100 (lithium ion battery) according to this embodiment, and a similar material to a constitutional material for an electrode body of a conventional lithium ion battery may be used. For example, LiMn₂O₄, LiCoO₂, LiNiO₂, and so on, which are often used conventionally, may be used as the positive electrode material (positive electrode active material). An olivine-based positive electrode material such as LiFePO₄ or LiMnPO₄ may also be used. A carbon-based material such as graphite carbon or amorphous carbon (typically graphite carbon), a lithium-containing transition metal oxide or transition metal nitride, and so on may be used as the negative electrode material (negative electrode active material). Aluminum foil, for example, may be used favorably as the positive electrode collecting foil body, and copper foil, for example, may be used favorably as the negative electrode collecting foil body. A member constituted by a porous polyolefin-based resin may be used as the separator. A non-aqueous solution containing an appropriate amount of an appropriate electrolyte (for example, a lithium salt such as LiPF₆), for example a mixed solution of diethyl carbonate and ethylene carbonate, may be used favorably as the electrolyte (typically a liquid electrolyte). When a solid electrolyte or a gel-form electrolyte is used instead of a liquid electrolyte, the resin separator described above may not be required (in this case, the electrolyte itself can function as a separator).

Next, referring to FIGS. 1 to 5, the structure and manufacturing method of the sealed battery 100 according to this embodiment will be described in detail. FIGS. 3 to 5 are schematic sectional views illustrating other embodiments of the manner in which the positive electrode terminal 64 is fixed to the terminal extraction portion 40. Note that in the drawings, the positive electrode terminal 64 is not shown in cross-section. First, the battery container 10 is prepared (manufactured). The container 10 is preferably formed from an identical metallic material to the lid main body 30 of the lid body 20, to be described below. Thus, the container 10 can be worked into a predetermined shape (an angular shape, for example) easily. In this embodiment, a closed-end angular (box-shaped) battery container 10 in which the opening portion 12 is provided in one end portion is prepared. Next, the lid body 20 is prepared (manufactured). The lid main body 30 of the lid body 20 is molded by working (cutting) a plate body (thickness 1 mm, for example) constituted by a flexible metallic material (preferably a 1000 Series aluminum alloy material such as A1050, for example) into a predetermined shape (i.e. a similar shape to the shape of the opening peripheral edge portion 14 of the battery container 10).

Next, holes for inserting the positive electrode terminal 64 and the negative electrode terminal 74 are formed in predetermined positions of the lid main body 30. The holes are typically drilled one at a time in locations near the two end portions of the battery container 10 (lid main body 30) in the lengthwise direction P. To form holes having a predetermined hole diameter in the plate-shaped lid main body 30, for example, a small hole is formed by inserting a drill-shaped tool into the lid main body 30, whereupon the hole is widened to the predetermined hole diameter (4 mm, for example). At this time, a burr formed on the peripheral edge of the widened hole is raised (caused to project) slightly from the surface of the lid main body 30 in an insertion direction of the aforementioned tool. The projecting burr part is then bent so as to tilt in an outer side direction of the hole, whereupon a tip end portion of the burr part is bent so as to turn inward. A projecting part formed by bending the burr part in this manner may be used as the projecting portion 34 of the terminal extraction portion 40. The projecting portion 34 may also be formed by trimming the burr part. When this method is employed, the projecting portion 34 can be formed integrally with the lid main body 30 rather than joining the projecting portion 34 to the lid main body 30 via a joint. Alternatively, the projecting portion 34 may be formed integrally with the lid main body 30 when the lid main body 30 is pressed molded or the like. The upper end surface 34a of the projecting portion 34 serves as a joint surface with the crimp formation portion 42, which is formed from a different material to the projecting portion 34 (the lid main body 30), and therefore the upper end surface 34a is preferably flat and substantially parallel to the parts of the lid main body 30 other than the projecting portion 34. Further, the joint between the crimp formation portion 42 and the lid main body 30 may be formed by removing the burr such that the projecting portion 34 is not provided, and joining the crimp formation portion 42 to the lid main body 30 by causing the lower end surface of the crimp formation portion 42 to contact the lid main body 30 directly.

Next, the crimp formation portion 42 is joined to the upper end surface 34a of the projecting portion 34 to form the terminal extraction portion 40. The crimp formation portion 42 is a cylindrical body having predetermined dimensions (for example, inner diameter 4 mm, outer diameter 8 mm, height 5 mm) and constituted by a high-strength metallic material (preferably a 2000 Series, 5000 Series or 6000 Series aluminum alloy material, for example A5052). One axial direction end surface (the lower end surface) of the crimp formation portion 42 is joined to the upper end surface 34a. Here, the projecting portion 34 and the crimp formation portion 42 are constituted by materials having different compositions (for example, aluminum alloy materials having different added element compositions). However, the joint between the upper end surface 34a of the projecting portion 34 and the crimp formation portion 42 can be formed locally using various joining methods. A preferred example of a local joining method is a solid-phase welding method such as friction stirring welding, friction bonding (friction welding), ultrasonic bonding (ultrasonic welding), and diffusion bonding. However, the joining method is not limited to a solid-phase welding method, and a welding method such as leaser beam welding or electron beam welding or the like may also be employed favorably. The joint of terminal extraction portion 40 for the positive electrode 60 was described above, but the joint of terminal extraction portion 50 for the negative electrode 70 is formed similarly.

The crimp formation portion 42 for the positive electrode 60 and a crimp formation portion 52 for the negative electrode 70 are joined to the lid main body 30 (the projecting portions 34 thereof) in the manner described above. Therefore, after the positive electrode terminal extraction portion 40 and the negative electrode terminal extraction portion 50 have been provided, the positive electrode terminal 64 and the negative electrode terminal 74 are inserted into the respective terminal insertion spaces formed so as to penetrate the axial center parts of the terminal extraction portions 40, 50 to connect to the respective collecting portions 62, 72 of the positive and negative electrodes 60, 70 of the electrode body 80. Here, the terminals 64, 74 may be connected to the respective collecting portions 62, 72 of the electrode body 80 before inserting the terminals 64, 74 into the respective terminal extraction portions 40, 50. However, to facilitate handling during insertion of the insulating member 90, the electrode body 80 is preferably connected after inserting the terminals 64, 74 into the terminal extraction portions 40, 50.

After inserting the positive electrode terminal 64 and the negative electrode terminal 74 into the respective terminal extraction portions 40, 50, the insulating member 90 is inserted into the respective gaps formed between the inner peripheral surface of the terminal extraction portions 40, 50 and the terminals 64, 74 so as to fill the gaps. After inserting the insulating member 90, the crimp (42a in FIG. 2 in relation to the terminal extraction portion 40) is formed in a predetermined position on the outer peripheral surface of the respective crimp formation portions 42, 52 of the terminal extraction portions 40, 50. The crimp is typically a rolling crimp (rotary crimp) formed by creating an indentation (flattening) the crimp formation portions 42, 52 in the circumferential direction at a predetermined width from the outside. A crimping diameter and a crimping strength may be modified appropriately in accordance with the material and diametrical dimension of the crimp formation portions 42, 52 and the insulating member 90. Note that there are no particular limitations on the order in which the electrode terminals 64, 74 are inserted into the terminal extraction portions 40, 50 and the insulating member 90 is inserted into the terminal extraction portions 40, 50. When the insulating member 90 is inserted into the terminal extraction portions 40, 50 before inserting the terminals 64, 74, the electrode body 80 is preferably connected to the terminals 64, 74 after the terminals 64, 74 are inserted. Further, the electrode terminals 64, 74 may be inserted into and crimped to the crimp formation portions 42, 52 in advance, whereupon the crimp formation portions 42, 52 are joined to the lid main body 30. Furthermore, when a high-strength resin material is used for the insulating member 90 and a high-strength metallic material is used for the crimp formation portions 42, 52, any gaps that may be formed between the inner peripheral surface of the terminal extraction portions 40, 50, the insulating member 90, and the respective electrode terminals 64, 74 are all completely sealed by implementing crimping as described above. Thus, the terminal extraction portions 40, 50 can be provided with a sealing structure having a sufficiently high degree of reliability.

As another embodiment of the structure of the terminal extraction portion 40 and the manner in which the positive electrode terminal 64 is fixed to the terminal extraction portion 40, “crimps” used in crimp formation portions 43 to 45 shown in FIGS. 3 to 5 may be employed. For example, in the embodiment shown in FIG. 3, a crimp formation portion 43 (terminal extraction portion 40) formed by connecting two cylindrical bodies having identical inner diameters and different outer diameters in a coaxial direction is employed. Of the two cylindrical bodies, the small-diameter cylindrical body side serves as a crimped portion 43b. To join the crimp formation portion 43 to the lid main body 30, the outer diameter dimension of the crimped portion 43b is substantially matched to the hole diameter of the terminal insertion hole provided in the lid main body 30, and the crimped portion 43b is inserted into the hole. A part of the crimped portion 43b that projects (downward) from the lid main body 30 is then bent (outward) into a radial shape and adhered to a rear surface (a surface on the side facing the opening portion 12 of the battery container 10) of the lid main body 30. Thus, the crimp formation portion 43 is attached Coined) to the lid main body 30. A crimp formed by bending the part (the crimped portion 43b) of the crimp formation portion 43 that projects from the rear surface of the lid main body 30 may also be employed favorably as a method of joining the lid main body 30 to the terminal extraction portion 40. When the positive electrode terminal 64 is fixed to the crimp formation portion 43 in this embodiment, a crimp is formed in a predetermined position (43a in FIG. 3) of the outer peripheral surface of the crimp formation portion 43 into which the positive electrode terminal 64 and the insulating member 90 are inserted, similarly to the crimp formation portion 42. With this embodiment, the positive electrode terminal 64 is crimped in the radial direction, which is orthogonal to the axial direction. Note that when the joint is formed in this manner, the projecting portion 34 need not be provided on the lid main body 30.

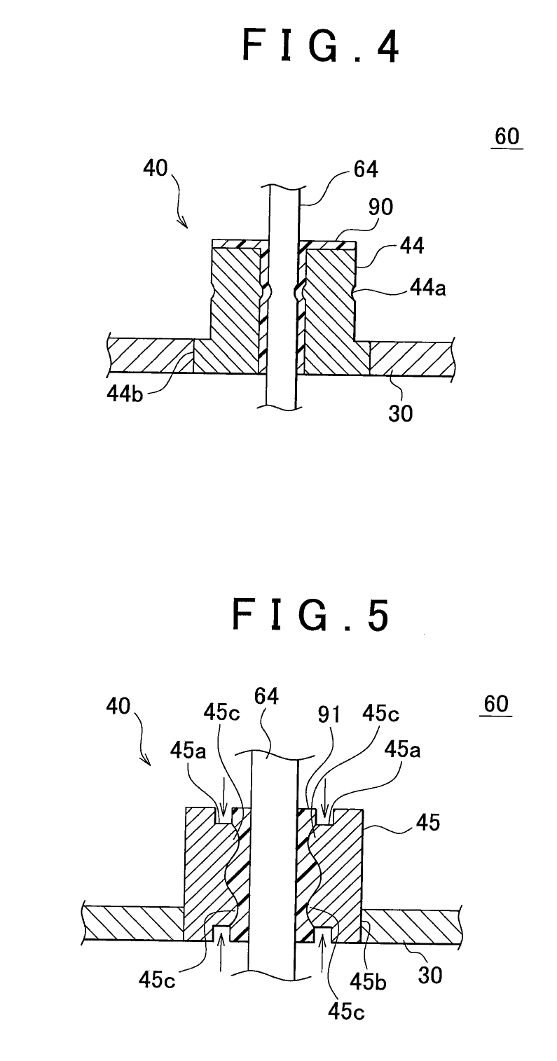

Further, in an embodiment shown in FIG. 4, a substantially cylindrical crimp formation portion 44 (terminal extraction portion 40) which is taller in the height direction than the crimp formation portion 42 is employed. This crimp formation portion 44 is fitted into a hole formed in the lid main body 30 having a larger hole diameter than the terminal insertion hole. A joint is then formed by welding (laser welding, for example) a contact surface between a predetermined part of the outer peripheral surface of the crimp formation portion 44 (in FIG. 4, an end face 44b of a collar portion formed around the entire circumference of the outer peripheral surface) and an inner wall surface of the hole formed in the lid main body 30, or the like. Thus, the crimp formation portion 44 is attached to the lid main body 30. When the positive electrode terminal 64 is fixed to the crimp formation portion 44 in this embodiment, a crimp is formed in a predetermined position (44a in FIG. 4) of the outer peripheral surface of the crimp formation portion 44 into which the positive electrode terminal 64 and the insulating member 90 are inserted, similarly to the crimp formation portion 42. With this embodiment also, the positive electrode terminal 64 is crimped in the radial direction, which is orthogonal to the axial direction. Note that the projecting portion 34 need not be provided on the lid main body 30.

Further, in an embodiment shown in FIG. 5, a cylindrical crimp formation portion 45 (terminal extraction portion 40) is employed. This crimp formation portion 45 is fitted into a hole formed in the lid main body 30 having a hole diameter that is larger than the terminal insertion hole and corresponds to an outer diameter of the crimp formation portion 45. The crimp formation portion 45 is attached to the lid main body 30 by joining a contact surface between a predetermined part of the outer peripheral surface of the crimp formation portion 45 (in FIG. 5, an outer peripheral surface portion 45b) and an inner wall surface of the hole formed in the lid main body 30 by welding (laser welding, for example) or the like. When the positive electrode terminal 64 is fixed to the crimp formation portion 45 in this embodiment, insertion hole peripheral parts (more specifically, insertion hole peripheral parts on an upper end surface and a lower end surface of the crimp formation portion 45 shown in FIG. 5) 45a of the crimp formation portion 45, which is penetrated by the positive electrode terminal 64 and a cylindrical synthetic resin insulating member 91 disposed on the periphery of the terminal 64, are pressurized (crimped) by pressing or the like in the axial direction of the positive electrode terminal 64. Thus, the peripheral parts (i.e. a part of the crimp formation portion 45) 45a are plastically deformed in an inner diameter direction of the insertion hole so as to jut into the inner wall surface of the insertion hole, and resulting jutting parts 45c press the positive electrode terminal 64 in the inner diameter direction via the insulating member 91. As a result, the positive electrode terminal 64 is fixed to the crimp formation portion 45. In this embodiment, the positive electrode terminal 64 is crimped in the radial direction by applying pressure to a part of the crimp formation portion 45 in the axial direction. Note that the crimp formation portion 45 may be joined to the lid main body 30 after fixing the positive electrode terminal 64 to the crimp formation portion 45.

As described above, the manner in which the positive electrode terminal 64 is fixed to the terminal extraction portion 40 is not limited to an embodiment in which the positive electrode terminal 64 is fixed by performing crimping in an inner radial direction toward the outer peripheral surface of the crimp formation portion 42 (43, 44), as shown in FIGS. 2 to 4, and also includes an embodiment in which the positive electrode terminal 64 is fixed by applying pressure to (crimping) the upper end surface and lower end surface of the crimp formation portion 45 in the axial direction of the positive electrode terminal 64, as shown in FIG. 5. The positive electrode 60 side terminal extraction portion 40 was described above, but the negative electrode 70 side terminal extraction portion 50 is identical.

After the respective electrode terminals 64, 74 have been fixed to the terminal extraction portions 40, 50 by crimping, the positive electrode collecting portion 62 and negative electrode collecting portion 72 of the electrode body 80 are connected respectively to the terminals 64, 74, whereupon the electrode body 80 is attached to the lid main body 30 via the respective terminals 64, 74. Note that the connection between the electrode body 80 and the electrode terminals 64, 74 is preferably formed such that the axial direction (lengthwise direction) of the rod-shaped electrode terminals 64, 74 is substantially orthogonal to the axial direction of the electrode body 80. By forming the connection in this manner, the axial direction of the electrode body 80 is parallel to the lengthwise direction of the lid main body 30 (i.e. the width direction P of the battery container 10) when the respective electrode terminals 64, 74 are inserted into the terminal extraction portions 40, 50.

The electrode body 80 fixed to the lid body 20 (the terminal extraction portions 40, 50 thereof) via the respective electrode terminals 64, 74 is housed in the battery container 10 together with a predetermined liquid electrolyte. The electrode body 80 may be submerged in the electrolyte in advance so that the electrode body 80 is sufficiently impregnated with the electrolyte via the separator 82. Finally, the opening portion 12 of the battery container 10 is closed by the lid body 20. The battery container 10 is then sealed by joining the peripheral edge portion 14 of the opening portion 12 to the peripheral edge portion 32 of the lid main body 30 of the lid body 20 using one of various joining methods. The joined peripheral edge portion 32 and opening peripheral edge portion 14 are formed from the same material (a high-purity, flexible aluminum alloy material), and therefore the two portions can be joined easily using the following joining methods. Preferred examples of the joining method include a double seaming method, a rolling crimping method, a laser beam welding method, and so on. As described above, with the sealed battery 100 according to this embodiment, the peripheral edge portion 14 of the opening portion 12 of the battery container 10 can be joined to the peripheral edge portion 32 of the lid main body 30 of the lid body 20 easily, and any gaps that may be formed in the terminal extraction portions 40, 50 provided in the lid main body 30, into which the electrode terminals 64, 74 are respectively inserted fixedly, can be closed reliably such that a superior sealing property can be maintained in the battery container 10. In other words, the battery 100 is capable of exhibiting both of these properties to a high degree.

The invention will now be described in further detail using the following example. However, the constitution of the invention is not limited to the matter cited in the example to be described below.

In this example, a terminal extraction portion was formed on a lid main body of a lid body, and the sealing property of a sealing structure of the terminal extraction portion was evaluated in a helium leak test. A corresponding procedure will now be described.

[Formation of Terminal Extraction Portion in Lid Main Body]

First, a plate body (lid main body) formed from an aluminum alloy (A1050) and having a thickness of 1 mm, a length (depth direction) of 13 mm, and a width (width direction) of 110 mm was prepared, whereupon a terminal insertion hole was punched in a predetermined position through pressing and a cylindrical projecting portion having approximate dimensions of height 1 mm, outer diameter 8 mm, and inner diameter 4 mm was formed. A cylindrical body (crimp formation portion) formed from an aluminum alloy (A5052) and having approximate dimensions of height 5 mm, outer diameter 8 mm, inner diameter 4 mm was then prepared. One axial end surface of the cylindrical body was aligned with an upper end surface of the projecting portion, whereupon the two surfaces were joined by friction bonding (solid phase welding) to form a crimp formation portion on the projecting portion. Thus, the cylindrical terminal extraction portion was formed on the lid main body. Next, an insulating member was prepared. A member formed from a high-strength insulating resin material such as PFA, PPS, PEEK and constituted by a cylindrical part contacting an inner peripheral surface of the terminal extraction portion and a flange part capable of covering an upper end surface (an end face on an opposite side to the end face joined to the projecting portion) of the crimp formation portion was used as the insulating member. The insulating member was inserted into the terminal extraction portion (i.e. a terminal insertion space formed in an axial center part thereof). Next, a rod-shaped positive electrode terminal formed from an A1050 aluminum alloy material and having a diameter of approximately 2 mm to 3 mm was inserted into the terminal insertion space formed in an axial center part of the insulating member. After inserting the positive electrode terminal, rotary crimping was performed at a crimp diameter of 2 mm in the vicinity of a central part of the crimp formation portion in a height direction, whereby the positive electrode terminal was fixed to the terminal extraction portion. Thus, the positive electrode side terminal extraction portion was manufactured with the positive electrode terminal fixed to the lid main body. Further, as a comparative example, the constitutional material of the crimp formation portion was modified from A5052 to A1050. Otherwise, the positive electrode terminal extraction portion was manufactured in an identical manner to that described above.

[Leak Test Evaluation]

An initial leak test was performed on the positive electrode terminal extraction portions relating respectively to the example and the comparative example manufactured as described above. More specifically, a vacuum method of a conventional helium leak test (JISZ2331) was implemented on the newly manufactured terminal extraction portions. The results of the test are shown in Table 1.

[Leak Test Evaluation Following Thermal Test]

Next, a thermal test (thermal shock test) was implemented on the respective terminal extraction portions and a leak amount was evaluated after the thermal test. The thermal test was implemented by subjecting the respective terminal extraction portions to low temperature (−40° C.) and high temperature (60° C.) thermal shock alternately for two hours each using a commercially available thermal shock tester and repeating the test over 100 cycles. A similar leak test to the initial leak test was performed after the thermal test. The results are shown in Table 1.

TABLE 1

| | LEAK AMOUNT | LEAK AMOUNT (AFTER |
|---|---|---|
| | (INITIAL) | THERMAL TEST) |
| EXAMPLE | NO MORE THAN 10⁻⁷ | NO MORE THAN 10⁻⁷ |
| (USING A5052) | [Pa × m³/sec] | [Pa × m³/sec] |
| COMPARATIVE | NO MORE THAN 10⁻⁷ | 10⁻³ [Pa × m³/sec] |
| EXAMPLE | [Pa × m³/sec] | |
| (USING A1050) | | |

As shown in Table 1, in the example, or in other words the positive electrode side terminal extraction portion having the crimp formation portion formed from A5052, which is a high-strength material, the leak amount did not vary from the initial leak amount after the thermal test, and therefore a superior sealing property was confirmed. In the comparative example, or in other words the positive electrode terminal extraction portion having the crimp formation portion formed from A1050, which is a low-strength (flexible) material, the leak amount increased by at least 10⁴ times in comparison with the initial value. Thus, a large reduction in the sealing property was confirmed. Hence, it was learned that by using a high-strength material for the crimp formation portion of the terminal extraction portion, any gaps that may be formed in the terminal extraction portion by the crimp are closed effectively, and that this effect is exhibited to a sufficiently high degree regardless of thermal shock and other loads.

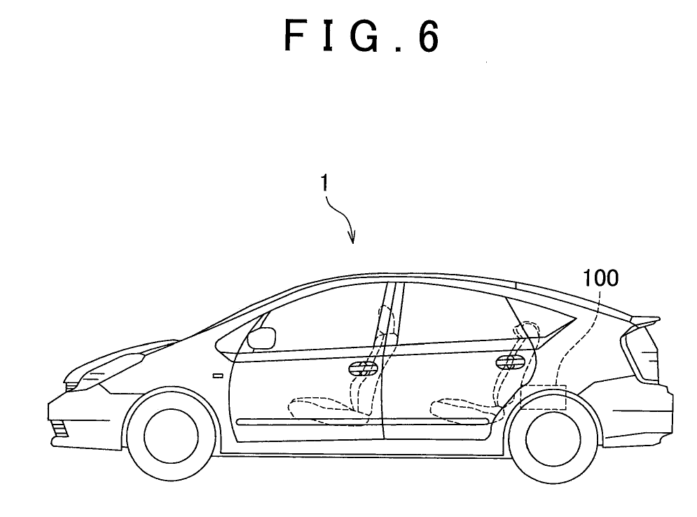

As is evident from the above example, the terminal extraction portion for fixing the electrode terminal to the lid body in a state where the electrode terminal is inserted therein so as to project from the lid body is sealed, and as a result, a superior sealing property can be maintained in the battery container over the long term. Furthermore, the opening peripheral edge portion of the battery container and the peripheral edge portion of the lid body can be joined easily. Hence, according to the invention, a sealed battery exhibiting both a superior sealing property and a superior joining property can be provided. Accordingly, the sealed battery of the invention is particularly suitable for use as a vehicle-installed power supply installed in a vehicle such as an automobile. As shown in FIG. 6, for example, according to the invention, a vehicle 1 (typically an automobile, in particular an automobile having a motor such as a hybrid automobile, an electric automobile, or a fuel cell automobile) including the sealed battery 100 constituted as described above as a power supply can be provided.

Preferred embodiments of the invention were described above, but the invention is not limited to these embodiments, and may be subjected to various modifications.

What is claimed is:

1. A sealed battery comprising:
a battery container;
a lid body attached to an opening portion of the battery container; and
a terminal extraction portion joined to the lid body, in which an electrode terminal is inserted fixedly,
wherein the battery container is sealed by joining a peripheral edge portion of the opening portion and a peripheral edge portion of the lid body and crimping the electrode terminal inserted into the terminal extraction portion of the lid body using the terminal extraction portion, and
at least a part of the terminal extraction portion in which the crimp is formed is constituted by a metallic material having a higher strength than a part of the lid body that is joined to the battery container.

2. The sealed battery according to claim 1, wherein at least the part of the terminal extraction portion in which the crimp is formed and a part of the lid body other than the crimp forming part are constituted by aluminum alloy materials having different hardness values.

3. The sealed battery according to claim 1, wherein at least the part of the terminal extraction portion in which the crimp is formed and the part of the lid body other than the crimp forming part are constituted by aluminum alloy materials having different added element compositions.

4. The sealed battery according to claim 1, wherein the battery container is constituted by an identical metallic material to the part of the lid body other than the terminal extraction portion.

5. The sealed battery according to claim 1, wherein an insulating member is disposed between the terminal extraction portion and the electrode terminal, and the electrode terminal is crimped via the insulating member.

6. The sealed battery according to claim 1, wherein at least the crimp forming part and the part of the lid body other than crimp forming part are joined by solid phase welding.

7. The sealed battery according to claim 1, wherein the peripheral edge portion of the opening portion and the peripheral edge portion of the lid body are joined by welding.

8. A vehicle comprising the sealed battery according to claim 1.

9. A sealed battery comprising:
a battery container;
a lid body attached to an opening portion of the battery container; and
a terminal extraction portion joined to the lid body, in which an electrode terminal is inserted fixedly,
wherein the battery container is sealed by joining a peripheral edge portion of the opening portion and a peripheral edge portion of the lid body and crimping the terminal extraction portion so that the electrode terminal inserted into the terminal extraction portion is fixed to the terminal extraction portion, and
at least a part of the terminal extraction portion in which the crimp is formed is constituted by a metallic material having a higher strength than a part of the lid body that is joined to the battery container.
